(19) United States
(12) Patent Application Publication
(10) Pub. No.: US 2014/0297607 A1
(43) Pub. Date: Oct. 2, 2014

(54) METHOD AND TERMINAL DEVICE FOR ORGANIZING STORAGE FILE

(71) Applicant: Tencent Technology (Shenzhen) Company Limited, Shenzhen (CN)

(72) Inventor: Meichen LIU, Shenzhen (CN)

(73) Assignee: Tencent Technology (Shenzhen) Company Limited

(21) Appl. No.: 14/305,390

(22) Filed: Jun. 16, 2014

Related U.S. Application Data
(63) Continuation of application No. PCT/CN2013/089327, filed on Dec. 13, 2013.

(30) Foreign Application Priority Data
Mar. 6, 2013 (CN) 201310070697.5

(51) Int. Cl. G06F 17/30

(52) U.S. Cl. CPC G06F 17/30135
USPC 707/693

(57) ABSTRACT

A method for organizing a storage file is described in the embodiments of the present disclosure. The method includes: performing predetermination for organizing and scanning on a selected storage file to determine whether the selected storage file needs to be scanned for fragmentation and organized; and scanning the selected storage file for fragmentation and organizing the storage file, if it is determined that the selected storage file needs to be scanned for fragmentation and organized. Thereby, the time spent on organizing the file is reduced and the efficiency for organizing the file is improved.

### CROSS-REFERENCES TO RELATED APPLICATIONS

This application claims priority to and is a continuation of PCT/CN2013/089327, filed on Dec. 13, 2013 and entitled “METHOD AND TERMINAL DEVICE FOR ORGANIZING STORAGE FILE”, which claims priority to Chinese Patent Application No. 201310070697.5, entitled “METHOD AND TERMINAL DEVICE FOR ORGANIZING STORAGE FILE”, filed with State Intellectual Property Office of the People's Republic of China on Mar. 6, 2013, which are incorporated herein by reference in their entireties.

### TECHNICAL FIELD

The present disclosure relates to the field of communication technologies, and in particular to a method and a terminal device for organizing a storage file.

### BACKGROUND

With the continuous development of the Internet, a computer has become a necessary in the life for the average consumers. However, the longer the computer is used, the more tile fragmentations are generated on the disk, and the discontinuous fragmentations may virtually increase the seek time of the disk. In the prior art, the individual fragmentations of a file are generally rearranged together by using a defragmentation technique, to achieve continuous location of the stored file on a physical disk, thereby optimizing the read-write performance of the disk.

However, although the prior art may organize completely the disk fragmentation, a long time is taken and thereby the efficiency for organizing is reduced.

### SUMMARY

A method and terminal device for organizing a storage file are provided according to the embodiments of the present disclosure, so as to reduce the time spent on organizing the file and improve the efficiency for organizing the file.

According to an embodiment of the disclosure, it is provided a method for organizing a storage file, which includes:

performing predetermination for organizing and scanning on a selected storage file to determine whether the selected storage file needs to be scanned for fragmentation and organized; and

scanning the selected storage file for fragmentation and organizing the selected storage file, if it is determined that the selected storage file needs to be scanned for fragmentation and organized.

According to an embodiment of the disclosure, it is further provided a terminal device for organizing a storage file, which includes a receiving unit, a predetermining unit and an executing unit.

The receiving unit is configured to receive an instruction for organizing a selected storage file.

The predetermining unit is configured to perform predetermination for organizing and scanning on the selected storage file to determine whether the storage file needs to be scanned for fragmentation and organized.

The executing unit is configured to scan the storage file for fragmentation and organize the storage file, if the predetermining unit determines that the storage file needs to be scanned for fragmentation and organized.

According to an embodiment of the disclosure, it is further provided a storage medium, in which executable instructions are contained, wherein the executable instructions are configured to implement a method for organizing a storage file, and the method includes:

performing predetermination for organizing and scanning on a selected storage file to determine whether the selected storage file needs to be scanned for fragmentation and organized; and

scanning the selected storage file for fragmentation and organizing the selected storage file, if it is determined that the selected storage file needs to be scanned for fragmentation and organized.

The above-mentioned technical solution shows that the embodiments of the present disclosure have the following advantages. A number of ways of predetermination are performed on a storage file before the storage file is scanned for fragmentation and organized; then the storage file is scanned for fragmentation and organized, if it is determined that the storage file needs to be scanned for fragmentation and organized. It is not necessary for all of the storage files to be scanned for fragmentation and organized. Thereby, the time spent on organizing the file is reduced and the efficiency for organizing the file is improved.

### BRIEF DESCRIPTION OF THE DRAWINGS

FIG. 1 is an overall flowchart of a method for organizing a storage file according to an embodiment of the disclosure;

FIG. 2 is a specific flowchart of a method for organizing a storage file according to an embodiment of the disclosure;

FIG. 3 is a structural diagram of a terminal device applied to organize a storage file according to an embodiment of the disclosure;

FIG. 4 is a structural diagram of another terminal device applied to organize a storage file according to an embodiment of the disclosure; and

FIG. 5 is a specific structural diagram of a terminal device applied to organize a storage file according to an embodiment of the disclosure.

### DETAILED DESCRIPTION

Hereinafter, the embodiments of the present disclosure are described in detail in conjunction with the accompanying drawings.

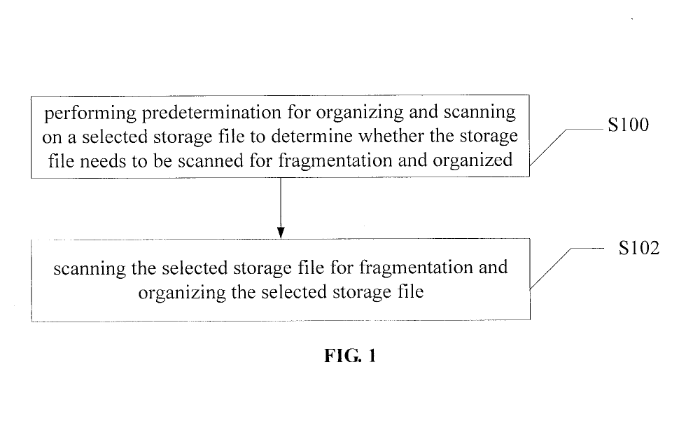

FIG. 1 is a flowchart of an example method for organizing a storage file according to an embodiment of the disclosure.

In the embodiment, various files are stored in a terminal device (such as a computer, a smart phone or a table computer). The longer the terminal device is used, the more files there are stored in the terminal device. Therefore, it is necessary to timely organize the storage file. In the embodiment, the storage file may include an editable file and a non-editable file. The editable file is a file of which the content can be modified by a user or an administrator. Generally, the editable files may include a file with a suffix such as .log, .txt, .docx, .doc, .wps, .db, .exl or .ppt. A non-editable file maybe a binary executable file with a suffIx.dll and so on, a file with a suffix of .pdf etc.

In the embodiment, Step S100: performing predetermination for organizing and scanning on a selected storage file to determine whether the storage file needs to be scanned for fragmentation and organized.

In the embodiment, it may be decided by the user when the storage file is organized. In this case, a system receives an organization instruction manually operated by the user. For example, the user may select an option in the human machine interface of the system to organize the storage file, and then the system may receive an operation instruction from the user. Alternatively, the system may automatically organize the storage file at a predetermined time. For example, in the system, the user may preset a plan for organizing the storage file at a predetermined time, and the system is triggered to start to organize the pre-selected storage file at the predetermined time. In this case, the system may receive an operation instruction sent by the system itself.

The system firstly determines whether there is an I/O read operation performed on a folder of the selected storage file, after receiving the instruction for organizing the selected storage file. The system determines whether the selected storage file is editable, if it is determined that there is an I/O read operation performed on the folder of the selected storage file. The system determines the rate of change of the selected storage file, if it is determined that the selected storage file is editable. The system determines that the selected storage file needs to be scanned for fragmentation and organized, if it is determined that the rate of change of the selected storage file is greater than 0. In the embodiment, I/O refers to write and read.

In the case where the system determines that there is no I/O read operation performed on the folder of the selected storage file, or determines that the selected storage file is non-editable, or determines that the rate of change of the selected storage file is not greater than 0, the system determines that the selected storage file does not need to be scanned for fragmentation and organized.

In the embodiment, Step S102 is performed if it is determined that the selected storage file needs to be scanned for fragmentation and organized.

Step S102: scanning the selected storage file for fragmentation and organizing the selected storage file. In the embodiment, the methods for the scanning for fragmentation and the organization in the prior art may be used, which is not described herein.

In the method for organizing a storage file according to the embodiment of the present disclosure, a number of ways of predetermination are performed on a storage file before the storage file is scanned for fragmentation and organized; then the storage file is scanned for fragmentation and organized, if it is determined that the storage file needs to be scanned for fragmentation and organized. It is not necessary for all of the storage files to be scanned for fragmentation and organized. Thereby, the time spent on organizing the file is reduced and the efficiency for organizing the file is improved.

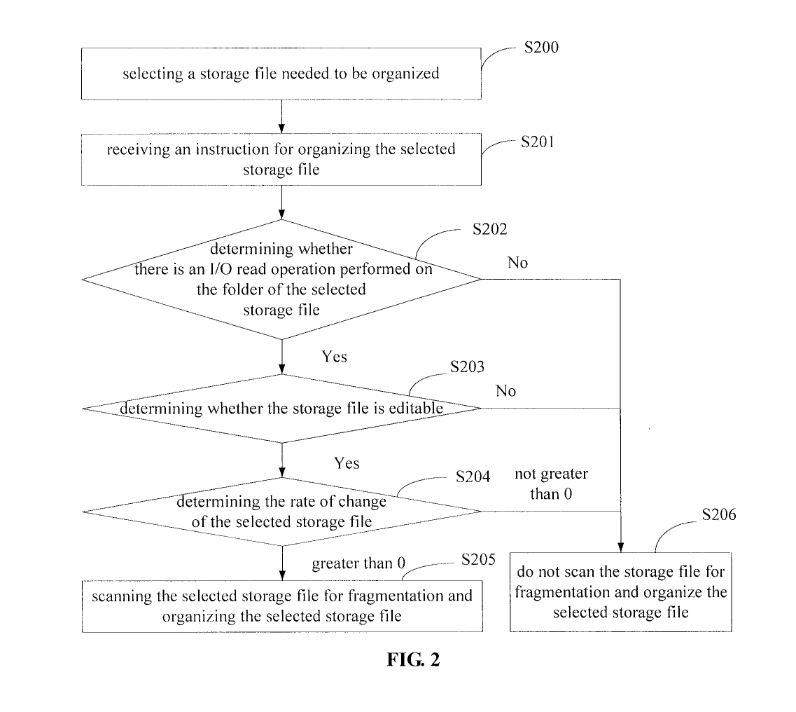

FIG. 2 is a specific flowchart of a method for organizing a storage file according to an embodiment of the present disclosure.

In the embodiment, various files are stored in a computer. The longer the computer is used, the more files there are stored in the computer. Therefore, it is necessary to timely organize the stored file. In the embodiment, the stored file may include an editable file and a non-editable file. The editable file is a file of which the content can be modified by a user or an administrator. Generally, the editable files may include a file with a suffix such as .log, .txt, .docx, .doc, .wps, .db, .exl or .ppt. The non-editable file is a binary executable file with a suffix of .dll and so on and a file with a suffix of .pdf.

In the embodiment, Step S200: selecting a storage file needed to be organized.

In the embodiment, firstly the user may select a storage file needed to be organized, and then the system may select the storage file needed to be organized from a storage unit according to a selection instruction from the user.

Alternatively, the system may select in advance the storage file needed to be organized from the storage unit according to a preset from the user. For example, all or part of the storage files on one disk may be selected to be organized. Optionally, the storage files on all of the disks may be selected to be organized. Optionally, the same type of the storage files may be selected to be organized. Optionally, the storage files under the operation authority of the user may be selected to be organized.

Step S201: receiving an instruction for organizing the selected storage file. In the embodiment, it may be decided by the user when the storage file is organized. In this case, a system receives the instruction manually operated by the user. For example, the user may select an option in the human machine interface of the system to organize the storage file, and then the system may receive the operation instruction from the user. Alternatively, the system may automatically organize the storage file at a predetermined time. For example, in the system, the user may preset a plan for organizing the storage file at the predetermined time, and the system is triggered to start to organize the pre-selected stored file at the predetermined time. In this case, the system may receive an operation instruction sent by the system itself.

Then, the system starts to scan a folder of the selected storage file.

Step S202: determining whether there is an I/O read operation performed on the folder of the selected storage file. In the embodiment, it is determined whether there is an I/O read operation performed on the folder of the selected storage file by determining whether a folder path of the selected storage file involves the I/O read operation.

In the embodiment, the folder path which does not involve the I/O read operation is the folder path that is only used for a file write operation and not for a file read operation in the system, for example, a folder path of a temporary folder does not involve the I/O read operation.

If it is determined that the folder path does not involve an I/O read operation, i.e. it is determined that there is no I/O read operation performed on the folder of the selected storage file, Step S206 is performed, that is, the selected storage file is not scanned for fragmentation and organized. If it is determined that the folder path involves the I/O read operation, i.e. it is determined that there is an I/O read operation performed on the folder of the selected storage file, Step S203 is performed.

Step S203: determining whether the storage file is editable. In the embodiment, whether the selected storage file is editable may be determined according to a suffix of the selected storage file, since the suffix of the editable file is different from that of a non-editable file.

In the embodiment, it is determined that the selected storage file is editable, in the case where the suffix of the selected storage file is .log, .txt, .docx, .doc, .wps, .db, .exl or .ppt.

In the embodiment, it is determined that the selected storage file is non-editable, in the case where the suffix of the selected storage file is not .log, .txt, .docx, .doc, .wps, .db, .exl or .ppt or is .dll or .pdf.

In the embodiment, if it is determined that the selected storage file is editable, Step S204 is performed. If it is determined that the selected storage file is non-editable, Step S206 is performed, that is, the selected storage file is not scanned for fragmentation and organized.

Step S204: determining the rate of change of the selected storage file.

In the embodiment, the rate of change of the selected storage file reflects the variation of the file size. In the embodiment, in the case where the rate of change of the selected storage file is less than or equal to 0, it is indicated that the size of the selected storage file is not increased, that is to say, there is no write operation performed on the selected storage file, and it is not necessary to scan the selected storage file for fragmentation and organize the selected storage file. In the case where the rate of change of the selected storage file is greater than 0, it is indicated that the size of the selected storage file is increased, that is to say, there is a write operation performed on the selected storage file, and it is necessary to scan the selected storage file for fragmentation and organize the selected storage file.

In the embodiment, the rate of change of the selected storage file may be determined from a system log of the selected storage file. The system log may include date of the file change, size of file modification, size of the file source, size of the file after being changed and so on. For example, the rate of change of the file may be the ratio of the increment in the size of the file to the period when the file increases, which is not limited to the present example.

In the embodiment, if it is determined that the rate of change of the selected storage file is less than or equal to 0, Step S206 is performed; and if it is determined that the rate of change of the selected storage file is greater than 0, Step S205 is performed.

Step S205: scanning the selected storage file for fragmentation and organizing the selected storage file. In the embodiment, the methods for the scan for fragmentation and the organization in the prior art may be used, which is not described herein.

In the method for organizing a storage file according to the embodiment of the disclosure, a number of ways of predetermination are performed on a storage file before the storage file is scanned for fragmentation and organized; then the storage file is scanned for fragmentation and organized, if it is determined that the storage file needs to be scanned for fragmentation and organized. It is not necessary for all of the storage files to be scanned for fragmentation and organized. Thereby, the time spent on organizing the file is reduced and the efficiency for organizing the file is improved.

FIG. 3 is a structural diagram of a terminal device applied to organize a storage file according to an embodiment of the disclosure.

In the embodiment, the terminal device includes a predetermining unit 302 and an executing unit 304.

In the embodiment, the predetermining unit 302 is configured to perform predetermination for organizing and scanning on a selected storage file to determine whether the selected storage file needs to be scanned for fragmentation and organized. In the embodiment, the predetermining unit 302 firstly determines whether there is an I/O read operation performed on a folder of the selected storage file. The predetermining unit 302 determines whether the selected storage file is editable, if it is determined that there is an I/O read operation performed on the folder of the selected storage file. The predetermining unit 302 determines the rate of change of the selected storage file, if it is determined that the selected storage file is editable. The predetermining unit 302 determines that the selected storage file needs to be scanned for fragmentation and organized, if it is determined that the rate of change of the selected storage file is greater than 0.

In the case where the predetermining unit 302 determines that there is no I/O read operation performed on the folder of the selected storage file, or determines that the selected storage file is not editable, or determines that the rate of change of the selected storage file is not greater than 0, the predetermining unit 302 determines that the selected storage file does not need to be scanned for fragmentation and organized.

The executing unit 304 is configured to scan the selected storage file for fragmentation and organize the selected storage file in the case where the predetermining unit 302 determines that the selected storage file needs to be scanned for fragmentation and organized.

In the terminal device for organizing a storage file according to the embodiment of the disclosure, a number of ways of predetermination are performed on a storage file before the storage file is scanned for fragmentation and organized; then the storage file is scanned for fragmentation and organized, if it is determined that the storage file needs to be scanned for fragmentation and organized. It is not necessary for all of the storage files to be scanned for fragmentation and organized. Thereby, the time spent on organizing the file is reduced and the efficiency for organizing the file is improved.

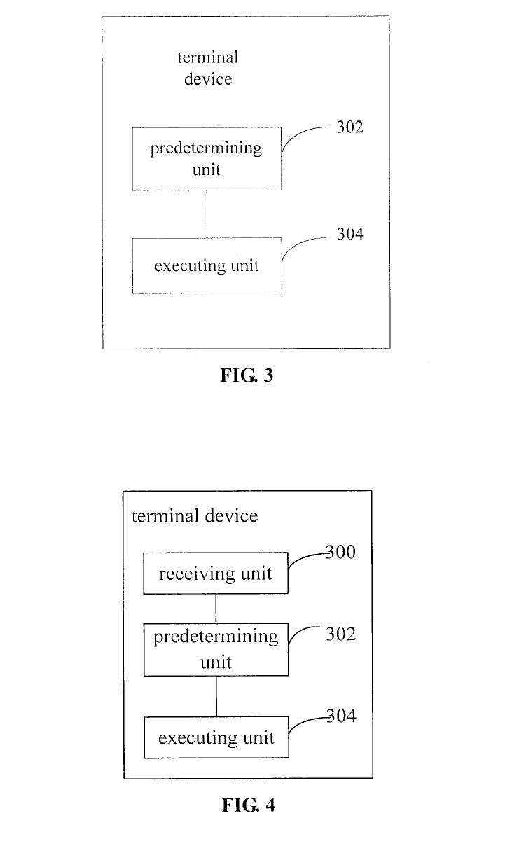

FIG. 4 is a structural diagram of other terminal device applied to organize a storage file according to an embodiment of the disclosure.

Compared with the terminal device in the previous embodiment, the terminal device in the present embodiment further includes a receiving unit 300.

The receiving unit 300 is configured to receive an instruction for organizing a selected storage file. In the embodiment, it may be decided by a user when the storage file is organized. In this case, the receiving unit 300 receives a organization instruction manually operated by the user. For example, the user may select an option in the human machine interface of the system to organize the storage file, and then the receiving unit 300 may receive an operation instruction from the user. Alternatively, the system may automatically organize the storage file at a predetermined time. For example, in the system, the user may preset a plan for organizing the storage file at a predetermined time, and the system is triggered to start to organize the selected storage file at the predetermined time. In this case, the receiving unit 300 may receive an operation instruction sent by the system itself.

The predetermining unit 302 is configured to perform predetermination for organizing and scanning on the selected storage file to determine whether the selected storage file needs to be scanned for fragmentation and organized, after the receiving unit 300 receives the instruction for organizing the selected storage file.

The executing unit 304 is configured to scan the selected storage file for fragmentation and organize the selected storage file in the case where the predetermining unit 302 determines that the selected storage file needs to be scanned for fragmentation and organized.

In the terminal device for organizing a storage file according to the embodiment of the disclosure, a number of ways of predetermination are performed on a storage file before the storage file is scanned for fragmentation and organized; then the storage file is scanned for fragmentation and organized, if it is determined that the storage file needs to be scanned for fragmentation and organized. It is not necessary for all of the storage files to be scanned for fragmentation and organized. Thereby, the time spent on organizing the file is reduced and the efficiency for organizing the file is improved.

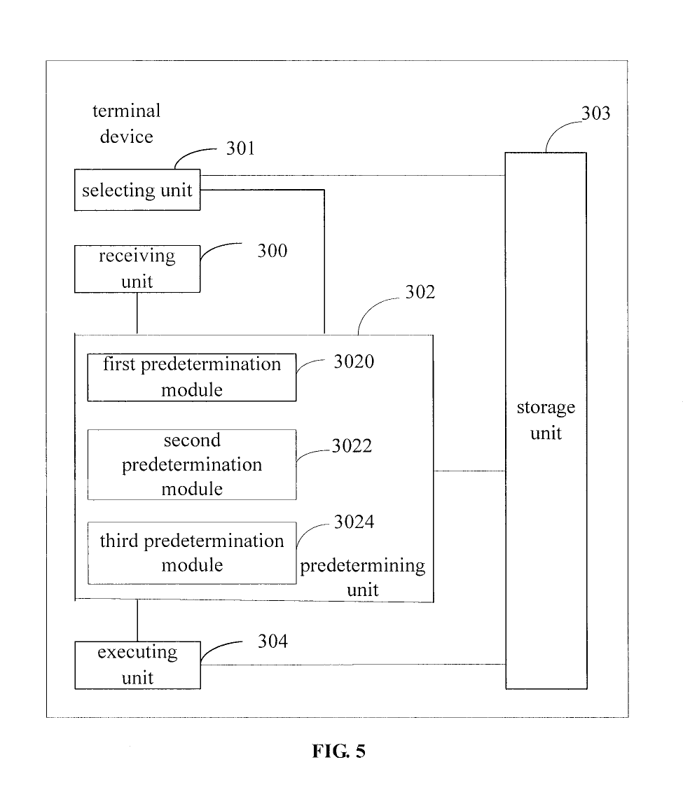

FIG. 5 is a specific structural diagram of a terminal device applied to organize a storage file according to an embodiment of the disclosure.

In the embodiment, the terminal device includes a receiving unit 300, a selecting unit 301, a predetermining unit 302, a storage unit 303 and an executing unit 304. The predetermining unit 302 includes a first predetermination module 3020, a second predetermination module 3022 and a third predetermination module 3024.

In the embodiment, the selecting unit 301 is configured to select a storage file needed to be organized. In the embodiment, the user may firstly select a storage file needed to be organized, and then the selecting unit 301 may select the storage file needed to be organized from the storage unit 303 according to the selection instruction from the user.

Alternatively, the selecting unit 301 may select in advance the storage file needed to be organized from the storage unit 303 according to a preset from the user. For example, all or part of the storage files on one disk may be selected to be organized. Optionally, the storages file on all of the disks may be selected to be organized. Optionally, the same type of the storage files may be selected to be organized. Optionally, the storage file under the operation authority of the current user may be selected to be organized.

In the embodiment, the receiving unit 300 is configured to receive an instruction for organizing the storage file selected by the selecting unit 301. In the embodiment, it may be decided by the user when the storage file is organized, and then the receiving unit 300 may receive an organization instruction manually operated by the user. For example, the user may select an option in the human machine interface of the system to organize the storage file. In this case, the receiving unit 300 may receive an operation instruction from the user. Alternatively, the system may automatically organize the storage file at a predetermined time. For example, in the system, the user may preset a plan for organizing the storage file at a predetermined time, and the system is triggered to start to organize the pre-selected storage file at the predetermined time. In this case, the receiving unit 300 may receive an operation instruction sent by the system itself.

The first predetermination module 3020 is configured to determine whether there is an I/O read operation performed on the folder of the storage file selected by the selecting unit 301. In the embodiment, it is determined whether there is an I/O read operation performed on the folder of the selected storage file by determining whether a folder path of the storage file involves the I/O read operation. In the embodiment, the folder path which does not involve the I/O read operation is the folder path that is only used for a file write operation and not for a file read operation in the system, for example, a folder path of a temporary folder does not involve the I/O read operation. If it is determined that the folder path does not involve the I/O read operation, the first predetermination module 3020 determines that there is no I/O read operation performed on the folder of the selected storage file.

The second predetermination module 3022 is configured to determine whether the selected storage file is editable if the first predetermination module 3020 determines that there is no I/O read operation performed on the folder of the selected storage file. In the embodiment, whether the selected storage file is editable may be determined according to a suffix of the selected storage file, since the suffix of the editable file is different from that of a non-editable file.

In the embodiment, it is determined that the selected storage file is editable, if the suffix of the selected storage file is .log, .txt, .docx, .doc, .wps, .db, .exl or .ppt.

In the embodiment, it is determined that the selected storage file is non-editable, if the suffix of the selected storage file is not .log, .txt, .docx, .doc, .wps, .db, .exl or .ppt or is .dll or .pdf.

The third predetermination module 3024 is configured to determine the rate of change of the selected storage file if the second predetermination module 3022 determines that the selected storage file is editable.

In the embodiment, the rate of change of the selected storage file reflects the variation of the file size. In the embodiment, in the case where the rate of change of the selected storage file is less than or equal to 0, it is indicated that the size of the selected storage file is not increased, that is to say, there is no write operation performed on the selected storage file, and it is not necessary to scan the selected storage file for fragmentation and organize the selected storage file. In the case where the rate of change of the selected storage file is greater than 0, it is indicated that the size of the selected storage file is increased, that is to say, there is a write operation performed on the selected storage file, and it is necessary to scan the selected storage file for fragmentation and organize the selected storage file.

The third predetermination module 3024 is further configured to determine that the selected storage file does not need to be scanned for fragmentation and organized, if it is determined that the rate of change of the selected storage file is less than or equal to 0. The third predetermination module 3024 is further configured to determine that the selected storage file needs to be scanned for fragmentation and organized, if it is determined that the rate of change of the selected storage file is greater than 0.

The executing unit 304 is configured to scan the selected storage file for fragmentation and organize the selected storage file if the third predetermination module 3024 determines that the selected storage file needs to be scanned for fragmentation and organized.

In the terminal device for organizing a storage file according to the embodiment of the disclosure, a number of ways of predetermination are performed on a storage file before the storage file is scanned for fragmentation and organized; then the storage file is scanned for fragmentation and organized, if it is determined that the storage file needs to be scanned for fragmentation and organized. It is not necessary for all of the storage files to be scanned for fragmentation and organized. Thereby, the time spent in organizing the file is reduced and the efficiency for organizing the file is improved.

It may be understood to those ordinary skilled in the art that all or part of the steps in the method according to the above-mentioned embodiments may be achieved by a program instructing the related hardware. The program may be stored in a computer readable storage medium. The above-mentioned storage medium may be a read-only memory (ROM), a magnetic disk, an optical disk and so on.

In the foregoing, a method and a terminal device for organizing a storage file according to the disclosure are introduced in detail. For those ordinary skilled in the art, there may be changes both in the embodiment and the application range according to the conception of the embodiments of the disclosure. In view of the above, it should not be considered that the content of the specification limits the disclosure.

What is claimed is:

1. A method implemented in a terminal device for organizing a storage file, the method comprising:
performing predetermination for organizing and scanning on a selected storage file to determine whether the selected storage file needs to be scanned for fragmentation and organized; and
in response to determining that the selected storage file needs to be scanned for fragmentation and organization, scanning the selected storage file for fragmentation and organizing the selected storage file.

2. The method of claim 1, wherein the performing predetermination for organizing and scanning on the selected storage file to determine whether the selected storage file needs to be scanned for fragmentation and organized comprises:
determining whether there is an I/O read operation performed on a folder of the selected storage file.

3. The method of claim 2 further comprises in response to determining that there is the I/O read operation performed on the folder of the selected storage file, determining whether the selected storage file is editable.

4. The method of claim 3 further comprises in response to determining that the selected storage file is editable determining the rate of change of the selected storage file.

5. The method of claim 4 further comprises in response to determining that the rate of change of the selected storage file is greater than 0, determining that the selected storage file needs to be scanned for fragmentation and organized.

6. The method according to claim 2, wherein determining whether there is an I/O read operation performed on a folder of the selected storage file comprises determining whether a folder path of the selected storage file involves the I/O read operation.

7. The method of claim 6 further comprises in response to determining that the folder path involves the I/O read operation, determining that there is the I/O read operation performed on the folder of the selected storage file.

8. The method of claim 3, wherein determining that the selected storage file is editable is based on determining that a suffix of the selected storage file is .log, .txt, .docx, .doc, .wps, .db, .exl or .ppt.

9. The method according to claim 4, wherein determining the rate of change of the selected storage file comprises determining the rate of change of the selected storage file from a system log of the selected storage file.

10. A terminal device for organizing a storage file, comprising a predetermining unit and an executing unit,
wherein the predetermining unit is configured to perform predetermination for organizing and scanning on a selected storage file to determine whether the selected storage file needs to be scanned for fragmentation and organized; and
the executing unit is configured to scan the selected storage file for fragmentation and organize the selected storage file, if the predetermining unit determines that the selected storage file needs to be scanned for fragmentation and organized.

11. The terminal device of claim 10 further comprising:
a receiving unit, configured to receive an instruction for organizing the selected storage file.

12. The terminal device of claim 10, wherein the predetermining unit comprises:
a first predetermination module, configured to determine whether there is an I/O read operation performed on a folder of the selected storage file;
a second predetermination module, configured to determine whether the selected storage file is editable, if the first predetermination module determines that there is the I/O read operation performed on the folder of the selected storage file; and
a third predetermination module, configured to determine the rate of change of the selected storage file, if the second predetermination module determines that the selected storage file is editable; and determine that the selected storage file needs to be scanned for fragmentation and organized, if it is determined that the rate of change of the selected storage file is greater than 0.

13. The terminal device of claim 12, wherein the first predetermination module is further configured to determine whether a folder path of the selected storage file involves the I/O read operation, and determine that there is the I/O read operation performed on the folder of the selected storage file, if it is determined that the folder path involves the I/O read operation.

14. The terminal device of claim 12, wherein the second predetermination module is further configured to determine that the selected storage file is editable, if a suffix of the storage tile is .log, .txt, .docx, .doc, .wps, .db, .exl or .ppt.

15. The terminal device of claim 12, wherein the third predetermination module is further configured to determine the rate of change of the selected storage file from a system log of the selected storage file.

16. A non-transitory storage medium in which executable instructions are stored, wherein the executable instructions when executed by a terminal device cause the terminal device to:
perform predetermination for organizing and scanning on a selected storage file to determine whether the selected storage file needs to be scanned for fragmentation and organized; and
scan the selected storage file for fragmentation and organizing the selected storage file, if it is determined that the selected storage file needs to be scanned for fragmentation and organized.

17. The non-transitory storage medium of claim 16 wherein the instructions for performing predetermination comprise executable instructions that when executed by the terminal device cause the terminal device to perform the steps of:
determining whether there is an I/O read operation performed on a folder of the selected storage file;
determining whether the selected storage file is editable;
determining the rate of change of the selected storage file; and
determining that the selected storage file needs to be scanned for fragmentation and organized, if it is determined that the rate of change of the selected storage file is greater than 0.
